(19) United States
(12) Patent Application Publication
(10) Pub. No.: US 2023/0230784 A1
(43) Pub. Date: Jul. 20, 2023

(54) An encoder switch with side pressing function

(71) Applicant: DONGGUAN CITY KAIHUA ELECTRONICS CO.LTD, Dongguan, Guangdong (CN)

(72) Inventors: Fuxi Wu, Dongguan, Guangdong (CN); Yu Wu, Dongguan, Guangdong (CN)

(21) Appl. No.: 17/927,862

(22) PCT Filed: Jun. 29, 2021
(86) PCT No.: PCT/CN2021/103031

§ 371 Date: Nov. 25, 2022

(30) Foreign Application Priority Data
Jun. 22, 2020 (CN) 202021171038.2

(51) Int. Cl. H01H 19/14; H01H 19/04; H01H 9/00

(52) U.S. Cl. CPC H01H 19/14; H01H 19/04; H01H 9/00

(57) ABSTRACT

The utility model discloses an encoder switch with side pressing function, which includes an encoder body and a touch switch arranged on the back of the encoder body, wherein the end of the rotating shaft of the encoder body extends to the end face of the touch switch. The encoder switch with the side press function provided by the utility model has the encoder function, and also gives the side press touch switch function, so that the encoder switch function is increased, the practicability is improved, and the application range is wider.

### TECHNICAL FIELD

The utility model relates to an encoder, in particular to an encoder switch with a side press function.

### BACKGROUND ART

Encoder is a kind of component commonly used in electronic products. It is usually operated by rotating the encoder to realize the menu selection function. However, this encoder has a single function and low practicability.

### SUMMARY OF THE UTILITY MODEL

In view of the above shortcomings, the utility model aims to provide an encoder switch with side pressing function, which not only has the encoder function, but also gives it the side pressing touch switch function, so that the encoder switch function is increased, the practicability is improved, and the application range is wider.

The technical scheme adopted by the utility model to achieve the above purpose is:

An encoder switch with side pressing function includes an encoder body, and is characterized in that it also includes a touch switch arranged on the back of the encoder body, wherein the end of the rotating shaft of the encoder body extends to the end face of the touch switch.

As a further improvement of the utility model, a plurality of positioning posts are protruded on the back of the encoder body, and a plurality of positioning holes for inserting the positioning posts are formed on the end face of the touch switch.

As a further improvement of the utility model, the touch switch includes a base, a first conductive terminal arranged on the base and extending to the outside, a second conductive terminal arranged on the base and extending to the outside, a metal dome arranged on the base, and a thin film arranged on the base and facing the metal dome, wherein the edge of the metal dome contacts with the first conductive terminal and the middle part of the metal dome is directly in front of the second conductive terminal; the end of the rotating shaft of the encoder body extends to the end face of the thin film, and is directly opposite to the middle of the metal dome.

As a further improvement of the utility model, a groove is formed on the side surface of the base for embedding a metal dome. The first conductive terminal has two first contact terminals exposed in the groove, and the second conductive terminal has a second contact terminal exposed in the groove. The edge of the metal dome is in contact with the two first contact terminals, and the metal dome is directly in front of the second contact terminals.

The beneficial effects of the utility model is that: by integrating the touch switch with the ultra-small encoder body, the encoder switch has the encoder function, and at the same time, and give it the side press touch switch function, so that the encoder switch function is increased, and both of them are independent in structure and function, and do not interfere with each other, so that the practicability is improved and the application range is wider.

The above is an overview of the technical scheme of the utility model. The utility model will be further explained below with reference to the attached drawings and specific implementation methods.

### BRIEF DESCRIPTION OF THE DRAWINGS

FIG. 1 is a schematic diagram of the overall structure of the utility model;

FIG. 2 is the overall explosion diagram of the utility model;

FIG. 3 is an explosion diagram of touch switch in the utility model.

### DETAILED DESCRIPTION OF THE UTILITY MODEL

In order to further explain the technical means and efficacy adopted by the utility model to achieve the intended purpose, the specific implementation mode of the utility model will be explained in detail below with reference to the drawings and preferred embodiments.

Please refer to FIG. 1, the embodiment of the utility model provides an encoder switch with side pressing function, which includes an encoder body 1 and a touch switch 2 arranged on the back of the encoder body 1, wherein the end of the rotating shaft 11 of the encoder body 1 extends to the end face of the touch switch 2. By integrating the touch switch 2 with the encoder body 1, the encoder switch not only has the encoder function, but also gives its side press touch switch function. When the specific function is realized, rotate the rotary shaft 11 to realize the encoder function, for example, select menu; press the rotating shaft 11 in the direction of touch switch 2 to realize the touch switch function, for example, confirm the menu.

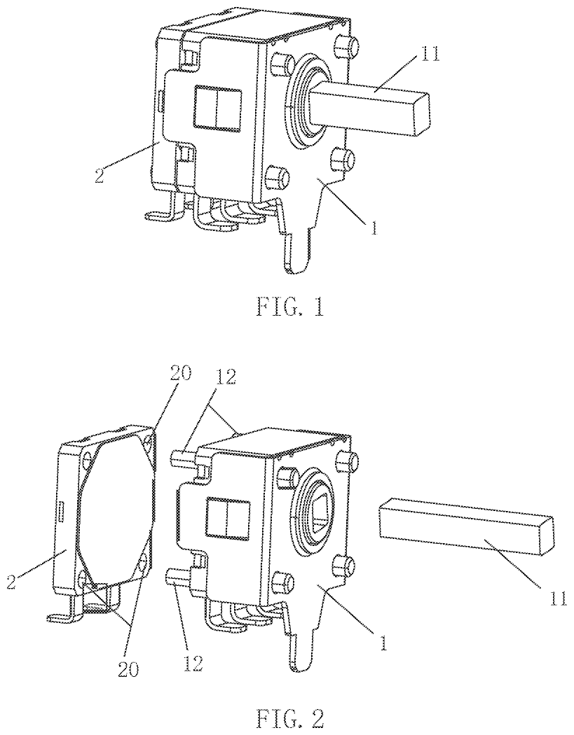

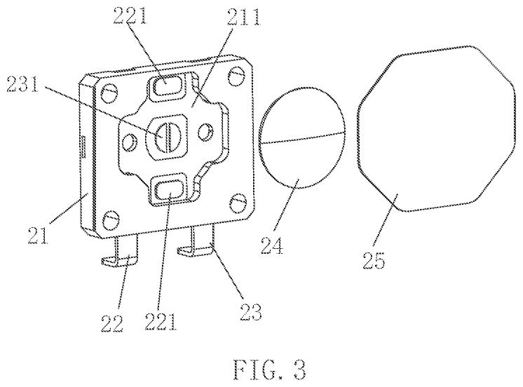

As for the combination of the touch switch 2 and the encoder body 1, as shown in FIG. 2, in this embodiment, a plurality of positioning posts 12 are protruded on the back of the encoder body 1, and a plurality of positioning holes 20 for inserting the positioning posts 12 are formed on the end face of the touch switch 2. The connection between the light touch switch 2 and the encoder body 1 is realized by combining several positioning posts 12 and several positioning holes 20. At the same time, the two can be fixed together by combining the hot riveting process.

In this embodiment, specifically, as shown in FIG. 3, the touch switch 2 includes a base 21, a first conductive terminal 22 disposed on the base 21 and extending to the outside, a second conductive terminal 23 disposed on the base 21 and extending to the outside, a metal dome 24 disposed on the base 21, and a thin film 25 disposed on the base 21 and facing the metal dome 24, wherein the edge of the metal dome 24 contacts the first conductive terminal 22, the middle part of the metal dome 24 is directly in front of the second conductive terminal 23; the end of the rotary shaft 11 of the encoder body 1 extends to the end face of the thin film 25, and is directly opposite to the middle of the metal dome 24.

Specifically, a groove 211 is formed on the side surface of the base 21 for embedding a metal dome 24. The first conductive terminal 22 has two first contact terminals 221 exposed in the groove 211, and the second conductive terminal 23 has a second contact terminal 231 exposed in the groove 211. The edge of the metal dome 24 is in contact with the two first contact terminals 221, the middle of the metal dome 24 is directly in front of the second contact endpoint 231

The working principle of the touch switch 2 is: when the metal dome 24 of the touch switch 2 is not pressed, because the metal dome 24 only contacts the two first contact terminals 221 of the first conductive terminal 22, but not the second conductive terminal 23, so that the first conductive terminal 22 and the second conductive terminal 23 are not connected. Therefore, the touch switch 2 is in an disconnected state

When the rotating shaft 11 of the encoder body 1 is pressed in the direction of the touch switch 2, the rotating shaft 11 contacts the thin film 25 and presses the middle of the metal dome 24, so that the middle of the metal dome 24 is deformed in the direction of the second contact terminal 231 of the second conductive terminal 23, and contacts the second contact terminal 231 of the second conductive terminal 23, so that the first conductive terminal 22 and the second conductive terminal 23 are connected, so that the touch switch 2 is in a conductive state.

When the pressing of the rotating shaft 11 is released, the metal dome 24 is elastically reset and separated from the second contact terminal 231 of the second conductive terminal 23, so that the first conductive terminal 22 and the second conductive terminal 23 return to the disconnected state, and the touch switch 2 is disconnected.

As shown in FIGS. 1 and 2, the conductive terminals (the first conductive terminal 22 and the second conductive terminal 23) of the touch switch 2 are independent of the conductive terminals of the encoder body 1. In specific use, it is only necessary to connect the conductive terminals of both to the PCB. Therefore, the functions of the touch switch 2 and the encoder body 1 are independent, and they do not interfere with each other. Both functions can be used at the same time, or only one of them can be selected.

The encoder body 1 in this embodiment can be made as small as possible in internal structure when it is manufactured, and can be as close to the internal structure as possible during the external glue coating. Therefore, the volume of the encoder body 1 can be made as small as possible, achieving the ultra-small encoder product. In this embodiment, the touch switch 2 is added on the back of the ultra-small encoder product, which gives the encoder product with more functions. The specific structure and working principle of the encoder body 1 are the same as those of conventional encoders in the field.

The encoder switch provided by this embodiment can be widely used in electronic products, especially in watches.

The above is only a preferred embodiment of the utility model, and does not limit the technical scope of the utility model. Therefore, other structures obtained by adopting the same or similar technical features as the above embodiments of the utility model are within the protection scope of the utility model.

What is claimed is:

1. An encoder switch with side pressing function, including an encoder body, characterized in that, it also includes a touch switch arranged on the back of the encoder body, wherein the end of the rotating shaft of the encoder body extends to the end face of the touch switch.

2. The encoder switch with side pressing function according to claim 1, characterized in that, a plurality of positioning posts are protruded on the back of the encoder body, and a plurality of positioning holes for inserting the positioning posts are formed on the end face of the touch switch.

3. The encoder switch with side pressing function according to claim 1, characterized in that, the touch switch includes a base, a first conductive terminal arranged on the base and extending to the outside, a second conductive terminal arranged on the base and extending to the outside, a metal dome arranged on the base, and a thin film arranged on the base and facing the metal dome, wherein the edge of the metal dome is in contact with the first conductive terminal, and the middle part of the metal dome is directly in front of the second conductive terminal; the end of the rotating shaft of the encoder body extends to the end face of the thin film, and is directly opposite to the middle of the metal dome.

4. The encoder switch with side pressing function according to claim 3, characterized in that, a groove is formed on the side surface of the base for embedding a metal dome, the first conductive terminal has two first contact terminals exposed in the groove, the second conductive terminal has a second contact terminal exposed in the groove, the edge of the metal dome is in contact with the two first contact terminals, and the metal dome is directly in front of the second contact terminals.
